(19) United States
(12) Patent Application Publication
(10) Pub. No.: US 2007/0278348 A1
(43) Pub. Date: Dec. 6, 2007

(54) APPARATUS FOR OPENING AIRFRAME OF MISSILE BY PYROTECHNICAL POWER

(76) Inventors: Tae-Hak Park, Daejeon (KR); Myong-Shik Won, Daejeon (KR); Choon-Kil Kang, Daejeon (KR)

Correspondence Address: OSTROLENK FABER GERB & SOFFEN, 1180 AVENUE OF THE AMERICAS, NEW YORK, NY, 100368403, US

(21) Appl. No.: 11/617,805

(22) Filed: Dec. 29, 2006

(30) Foreign Application Priority Data
Jun. 2, 2006 (KR) 10-2006-0050079

(51) Int. Cl. B64C 1/14

(52) U.S. Cl. 244/129.4

(57) ABSTRACT

Disclosed is an apparatus for opening an upper and lower split-type airframe hinge-coupled to a propulsion unit of a missile and separating a payload mounted in the airframe. The apparatus for opening the airframe of the missile by pyrotechnical power includes: pressure generation units installed between the airframe and the payload, for generating explosion pressure; and pressure transmission units connected to the pressure generation units, for applying force by the explosion pressure to the payload, and opening the airframe by reaction force with the payload. The apparatus for opening the airframe of the missile reduces an installation space and cuts down a manufacturing cost by simplifying the configuration by decreasing a number of components, improves airframe opening performance by instantaneously opening the airframe in exact timing, and enables the user to adjust airframe opening force in a target level.

### RELATED APPLICATION

The present disclosure relates to subject matter contained in priority Korean Application No. 10-2006-0050079, filed on Jun. 2, 2006, which is herein expressly incorporated by reference in its entirety.

### BACKGROUND OF THE INVENTION

1. Field of the Invention

The present invention relates to an apparatus for opening an airframe of a missile, and more particularly, to an apparatus for opening an airframe of a missile by pyrotechnical power which can open the airframe of the missile by using pressure generated by powder explosion.

2. Description of the Background Art

In general, a missile for transferring and dropping a payload by using propulsive force of a propulsion unit includes an airframe unit for firmly coupling the payload to the propulsion unit. The missile separates the airframe from the payload after flying to near the target and satisfying a predetermined condition for separation, so that the payload can freely fly to a target point.

Accordingly, the airframe unit must serve as a structure as well as a mechanical device. The airframe unit has a split-type structure to be easily separated from the payload. That is, a hinge structure is formed at one end of the airframe unit, and an apparatus for opening an airframe is formed at the other end thereof.

Various methods of opening a split-type airframe have been suggested to separate the airframe unit from the payload firmly coupled to the airframe unit in a requested timing during flight of the missile.

U.S. Pat. No. 4,699,062 discloses a VLA airframe clamshell opener assembly which opens split airframes in the upper and lower directions by elastic force of compressed wave-shaped springs. This configuration installs the pair of wave-shaped springs between the split airframes and a payload to face each other in the radial direction, and radially outwardly urges the split airframes away by the elastic force stored in the springs.

U.S. Pat. No. 3,975,981 suggests another apparatus for separating two interconnected bodies. A separation spring actuator uses elastic force of a compressed coil spring. The separation spring actuator installed between the two interconnected bodies separates the interconnected bodies, maintaining their respective desired directions. This configuration can adjust separation force by varying initial compression of the compressed coil spring.

The conventional apparatus for opening or separating the airframe mostly uses the elastic force of the spring. However, there are continuous demands for an apparatus having a stronger force to open an airframe which occupies a narrower space between the airframe and a payload than the conventional apparatus, and which improves airframe opening performance.

### SUMMARY OF THE INVENTION

Therefore, an object of the present invention is to provide an apparatus for opening an airframe of a missile which can considerably reduce an installation space and increase a opening force remarkably, so that the apparatus can be installed in a narrow space between the airframe and a payload and improve airframe opening performance.

Another object of the present invention is to provide an apparatus for opening an airframe of a missile which can cut down manufacturing expenses by simplifying the configuration by decreasing a number of components.

Yet another object of the present invention is to provide an apparatus for opening an airframe of a missile which can improve airframe opening performance by instantaneously opening the airframe in exact timing.

Yet another object of the present invention is to provide an apparatus for opening an airframe of a missile which enables the user to adjust airframe opening force.

To achieve these and other advantages and in accordance with the purpose of the present invention, as embodied and broadly described herein, there is provided an apparatus for opening a split-type airframe hinge-coupled to a propulsion unit of a missile and separating a payload mounted in the airframe, the apparatus for opening the airframe of the missile, including: pressure generation units installed between the airframe and the payload, for generating explosion pressure; and pressure transmission units connected to the pressure generation units, for applying force by the explosion pressure to the payload, and opening the airframe by reaction force with the payload.

As compared with the conventional apparatus for opening the airframe using the elastic force of the compressed wave-shaped spring or coil spring, the apparatus for opening the airframe of the missile generates the explosion pressure in the pressure generation units installed between the airframe and the payload, and opens the airframe by the pressure.

The pressure transmission units connected to the pressure generation units transmit the explosion pressure generated by the pressure generation units to the payload. Here, the pressure transmission units are installed to generate a pair of reaction forces having the same size and opposite directions at the upper and lower portions of the payload, for opening the upper and lower split airframes at the same time.

The pressure transmission units include: cylinders fixed in the opposite directions in the diameter of the inner circumferences of each split airframe to face each other in the upper and lower portions of the payload, each pressure generation unit being inserted into one side of each cylinder, for generating the explosion pressure; and pistons having their one side inserted into each cylinder and their other side contact the outer circumference of the payload, receiving the explosion pressure generated inside the cylinders, and transmitting the explosion pressure to the payload.

Space units having a predetermined volume are formed between the pressure generation units and the pistons inside the cylinders, and the explosion pressure is generated in the space units. Therefore, the cylinders provide the generation spaces of the explosion pressure by the pressure generation units, and also provide the motion spaces of the pistons.

Here, the pistons move out of the cylinders, and apply force to the payload contacting the opposite sides at the same time by the explosion pressure generated in the space units of the cylinders. This operation simultaneously occurs in two opposite points in the diameter direction of the payload. Accordingly, the force which the pistons apply to the payload is converted into the reaction force, so that the split airframes can be opened at the same time.

Each of the pistons includes: an insertion unit inserted into the cylinder to be movable; and a contact unit being extended from the insertion unit as a single body with a larger cross section area than the insertion unit, and surface-contacting the payload.

In order to obtain the stable opening force, the contact units surface-contacting the payload have a larger cross section area than the insertion units, for increasing a transmission area of the force by the explosion pressure.

On the other hand, the pressure generation units inserted into the cylinders are pressure cartridges for generating the explosion pressure by electrically igniting inside powder. Large explosion pressure is instantaneously generated by electrically igniting the powder. As a result, the force of opening the airframe can be rapidly supplied in exact timing.

The user can adjust the airframe opening force in a target level by varying the size of the space units in the cylinders, or changing the amount of the powder filled in the pressure cartridges.

In addition, mounting grooves on which the cylinders are mounted are caved in the inner circumference of the airframe, for reducing the diameter of the airframe.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic assembly view illustrating a missile on which an apparatus for opening an airframe is mounted;

FIG. 2 is a cross-sectional view taken along line II-II of FIG. 1;

FIG. 3 is a detailed cross-sectional view illustrating the apparatus for opening the airframe in accordance with the present invention, seen from the side portion;

FIG. 4 is a detailed cross-sectional view illustrating the apparatus for opening the airframe in accordance with the present invention, seen from the front portion;

FIG. 5 is a structure view illustrating the operation of the apparatus for opening the airframe in accordance with the present invention; and

FIG. 6 is a detailed cross-sectional view taken along line VI-VI of FIG. 5.

### DETAILED DESCRIPTION OF THE INVENTION

Reference will now be made in detail to the preferred embodiments of the present invention, examples of which are illustrated in the accompanying drawings.

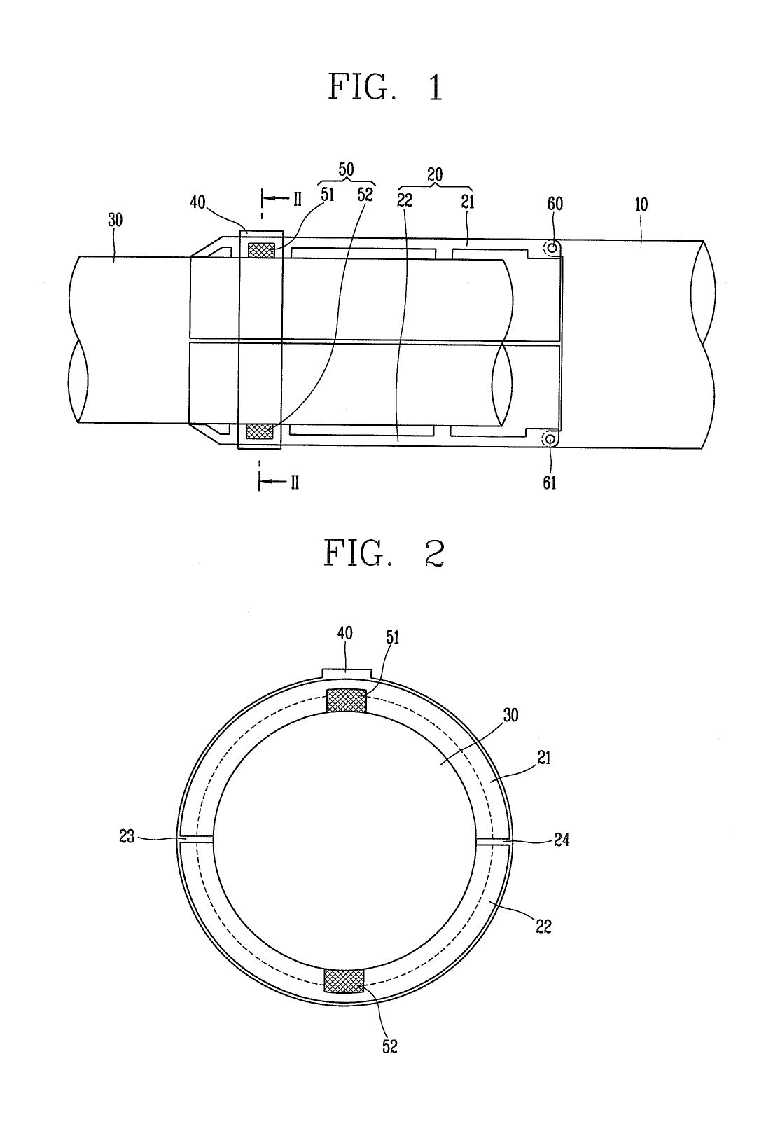

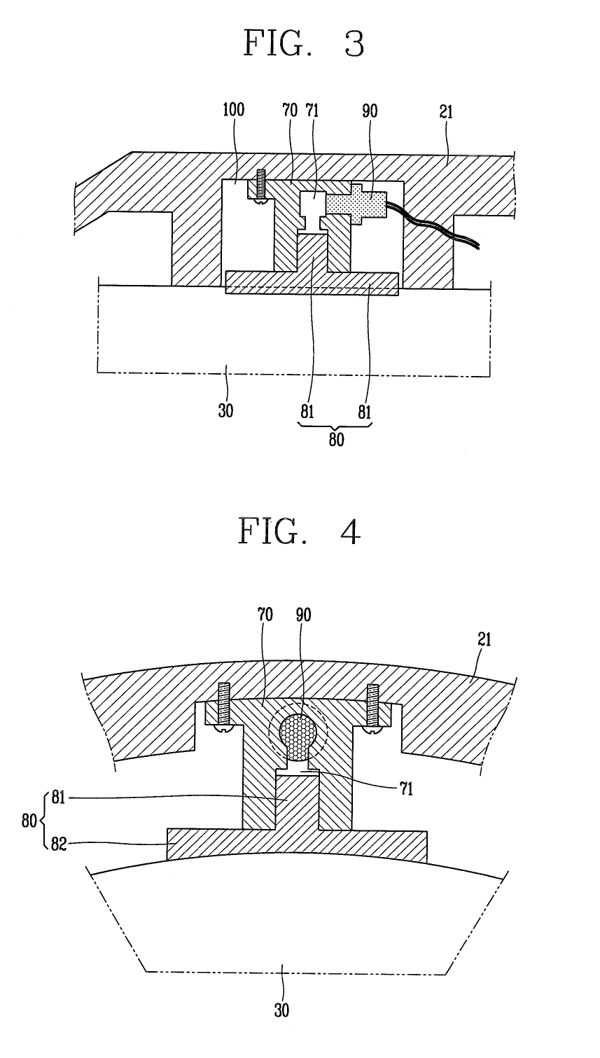

FIG. 1 is a schematic assembly view illustrating a missile on which an apparatus for opening an airframe is mounted, FIG. 2 is a cross-sectional view taken along line II-II of FIG. 1, and FIGS. 3 and 4 are detailed cross-sectional views illustrating the apparatus for opening the airframe in accordance with the present invention, seen from the side portion and the front portion, respectively.

Referring to FIG. 1, the apparatus 50 for opening the airframe 20 is installed between an upper and lower split-type airframe 20 hinge-coupled to a propulsion unit 10 for supplying propulsive force to the missile and a payload 30 mounted in the airframe 20.

The apparatus 50 for opening the airframe 20 is installed at the end of the front portion of the airframe 20 which is the opposite side to upper and lower hinge coupling units 60 and 61, for giving a strong moment when an upper split airframe 21 and a lower split airframe 22 are rotated on the hinge coupling units 60 and 61 and opened.

The upper and lower apparatuses 51 and 52 for opening the upper and lower split airframes 21 and 22 are installed in the upper and lower split airframes 21 and 22, respectively, for applying opening force to each split airframe 21 and 22. As illustrated in FIG. 2, the upper and lower apparatuses 51 and 52 are perpendicular to an imaginary line connecting two points 23 and 24 of splitting the airframe 20 into upper and lower portions, and installed at two opposite points in the diameter of the payload 30, for applying maximum opening force.

The detailed configuration of the apparatus for opening the airframe in accordance with the present invention will now be described with reference to FIGS. 3 and 4. Here, the upper and lower apparatuses 51 and 52 for opening the upper and lower split airframes 21 and 22 have the same configuration.

The apparatus 50 for opening the airframe 20 includes pressure generation units installed between the airframe 20 and the payload 30, for generating explosion pressure, and pressure transmission units connected to the pressure generation units, for applying force by the explosion pressure to the payload 30, and opening the airframe 20 by reaction force with the payload 30.

The pressure transmission units are installed to generate a pair of reaction forces having the same size and opposite directions at the upper and lower portions of the payload 30 in generation of the explosion pressure by the pressure generation units, for opening the upper and lower split airframes 21 and 22 at the same time.

The pressure transmission units include cylinders 70 fixed in the opposite directions in the diameter of the inner circumferences of each split airframe 21 and 22 to face each other in the upper and lower portions of the payload 30, each pressure generation unit being inserted into one side of each cylinder 70, for generating the explosion pressure; and pistons 80 having their one side inserted into each cylinder 70 and their other side contact the outer circumference of the payload 30, receiving the explosion pressure generated inside the cylinders 70, and transmitting the explosion pressure to the payload 30.

Space units 71 having a predetermined volume are formed between the pressure generation units and the pistons 80 inside the cylinders 70, and the explosion pressure is generated in the space units 71.

That is, the cylinders 70 provide the generation spaces of the explosion pressure by the pressure generation units, and also provide the motion spaces of the pistons 80.

Each of the pistons 80 includes an insertion unit 81 inserted into the cylinder 70 to be movable, and a contact unit 82 being extended from the insertion unit 81 as a single body with a larger cross section area than the insertion unit 81, and surface-contacting the payload 30.

In order to obtain the stable opening force, the contact units 82 have a larger cross section area than the insertion units 81, for forming an appropriate transmission area of the force by the explosion pressure. Preferably, the contact surfaces to the payload 30 are caved in a round shape with predetermined curvature to be closely adhered to the outer diameter of the payload 30.

On the other hand, the pressure generation units inserted into the cylinders 70 are pressure cartridges 90 for generating the explosion pressure by electrically igniting inside powder. The pressure cartridges 90 are inserted higher than the ends of the insertion units 81 of the pistons 80 to form the space units 71 for generating the explosion pressure in the cylinders 70. When the explosion pressure is generated by the pressure cartridges 90, the ends of the insertion units 81 of the pistons 80 directly receive the pressure.

Mounting grooves 100 on which the cylinders 70 are mounted are caved in the inner circumference of the airframe 20. Accordingly, when the apparatus 50 for opening the airframe 20 is installed, it is not necessary to enlarge the space between the airframe 20 and the payload 30.

The operation of the apparatus for opening the airframe in accordance with the present invention will now be described.

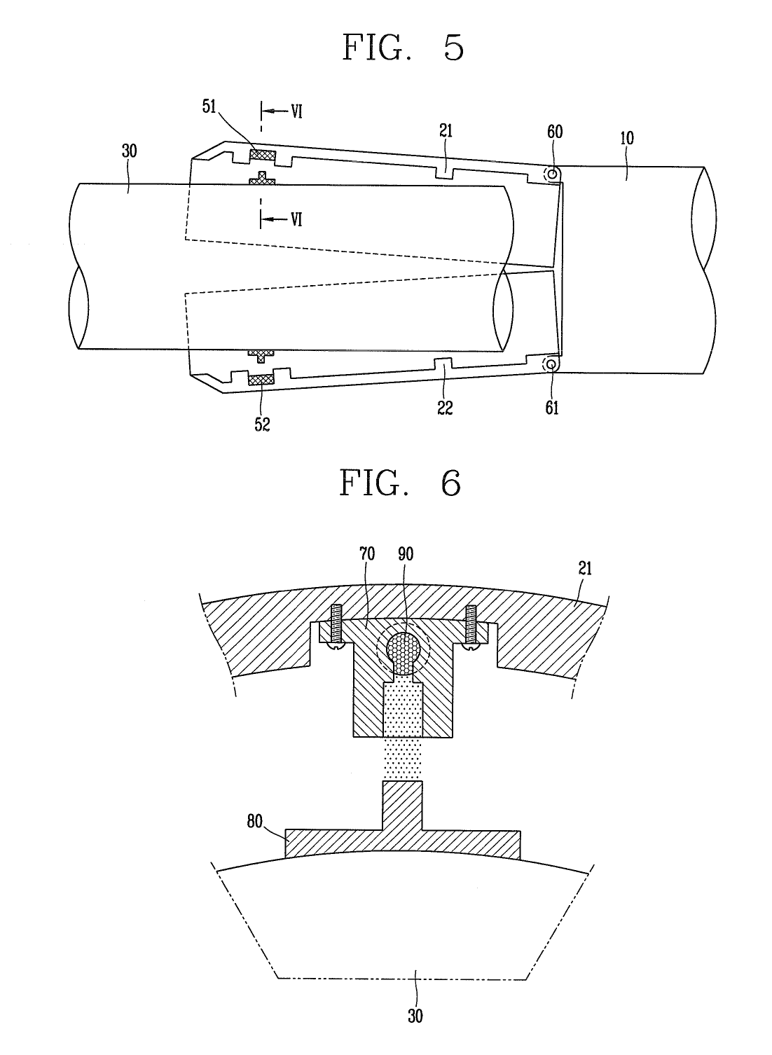

FIG. 5 is a structure view illustrating the operation of the apparatus for opening the airframe in accordance with the present invention, and FIG. 6 is a detailed cross-sectional view taken along line VI-VI of FIG. 5.

After the missile on which the payload 30 has been mounted is launched and flies for a predetermined time, if a mechanical apparatus 40 for maintaining the airframe 20 which firmly ties the payload 30 and the split-type airframe 20 by tension is cut by a cutting apparatus, high explosion pressure is generated in the space units 71 inside the cylinders 70 by ignition of the pressure cartridges 90 installed in each cylinder 70.

By the explosion pressure, the pistons 80 inserted into the cylinders 70 move out of the cylinders 70, and apply the force to the outer circumference of the payload 30 surface-contacting the opposite sides at the same time.

Since the upper and lower apparatuses 51 and 52 for opening the upper and lower split airframes 21 and 22 are disposed in the opposite sides in the diameter of the payload 30, not the payload 30 is moved, but the pair of reaction forces are generated in the two points in which the payload 30 surface-contacts the pistons 80. Therefore, the upper and lower split airframes 21 and 22 are pushed back and separated from the payload 30 in the radial direction.

The missile flies very fast in the air. The air flows very fast into the narrow gaps between the upper and lower split airframes 21 and 22 and the payload 30, to accelerate rotation of each split airframe 21 and 22 on the hinge coupling units 60 and 61.

A large drag of the air is operated on the opened upper and lower split airframes 21 and 22, thereby sharply decreasing the speed of the airframes 21 and 22. Accordingly, the airframe 20 is separated from the payload 30, and the payload 30 having an aerodynamically advantageous shape is free from the airframe 20 and enters a target flight orbit.

As discussed earlier, in accordance with the present invention, the apparatus for opening the airframe of the missile reduces the installation space and cuts down the manufacturing expenses by simplifying the configuration by decreasing the number of components.

In addition, the apparatus for opening the airframe of the missile improves the airframe opening performance by instantaneously opening the airframe in exact timing by using the explosion pressure of powder.

Furthermore, the apparatus for opening the airframe of the missile enables the user to adjust the airframe opening force in the target level, by varying the size of the space units inside the cylinders or the amount of the powder.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An apparatus for opening an upper and lower split-type airframe hinge-coupled to a propulsion unit of a missile and separating a payload mounted in the airframe, comprising:
pressure generation units installed between the airframe and the payload, for generating explosion pressure; and
pressure transmission units connected to the pressure generation units, for applying force by the explosion pressure to the payload, and opening the airframe by reaction force with the payload.

2. The apparatus as claimed in claim 1, wherein the pressure transmission units are installed to generate a pair of reaction forces having the same size and opposite directions at the upper and lower portions of the payload in generation of the explosion pressure by the pressure generation units, for opening the upper and lower split airframes at the same time.

3. The apparatus as claimed in claim 2, wherein the pressure transmission units comprise:
cylinders fixed in the opposite directions in the diameter of the inner circumferences of each split airframe to face each other in the upper and lower portions of the payload, each pressure generation unit being inserted into one side of each cylinder, for generating the explosion pressure; and
pistons having their one side inserted into each cylinder and their other side contact the outer circumference of the payload, receiving the explosion pressure generated inside the cylinders, and transmitting the explosion pressure to the payload.

4. The apparatus as claimed in claim 3, wherein space units having a predetermined volume are formed between the pressure generation units and the pistons inside the cylinders, and the explosion pressure is generated in the space units.

5. The apparatus as claimed in claim 3, wherein each of the pistons comprises:
an insertion unit inserted into the cylinder to be movable; and
a contact unit being extended from the insertion unit as a single body with a larger cross section area than the insertion unit, and surface-contacting the payload.

6. The apparatus as claimed in claim 3, wherein the pressure generation units are pressure cartridges for generating the explosion pressure by electrically igniting inside powder.

7. The apparatus as claimed in claim 3, wherein mounting grooves on which the cylinders are mounted are caved in the inner circumference of the airframe.
